(19) United States
(12) Patent Application Publication
(10) Pub. No.: US 2019/0272586 A1
(43) Pub. Date: Sep. 5, 2019

(54) VIRTUAL REALITY BASED SHOPPING METHOD AND SYSTEM

(71) Applicant: HUIZHOU TCL MOBILE COMMUNICATION CO., LTD., HuiZhou City, Guangdong (CN)

(72) Inventors: Yanliang HUANG, HuiZhou City, Guangdong (CN); Hufeng WU, HuiZhou City, Guangdong (CN)

(21) Appl. No.: 16/349,998

(22) PCT Filed: Oct. 31, 2017
(86) PCT No.: PCT/CN2017/108696

§ 371 Date: May 15, 2019

(30) Foreign Application Priority Data
Nov. 17, 2016 (CN) 201611012628.9

(51) Int. Cl. G06Q 30/06; G06T 19/20; G06T 17/05

(52) U.S. Cl. CPC G06Q 30/0643; G06T 19/20; G06T 17/05; G06T 2200/24; G06T 2200/08; G06T 2219/2021; G06T 2200/04

(57) ABSTRACT

Disclosed is a virtual reality based shopping method. The method includes: acquiring a user image and user information; establishing a shopping model corresponding to the user according to the user image and the user information; fitting clothes onto the shopping model when the clothes selected by a user are received; and transferring the shopping model having the clothes fitted thereon to a virtual reality device used by the user, wherein the virtual reality device presents the shopping model having the clothes fitted thereon.

### TECHNICAL FIELD OF THE INVENTION

The present invention relates to an intelligent terminal field, and more particularly to a virtual reality based shopping method and a system.

### BACKGROUND OF THE INVENTION

With the development of e-commerce, more and more people choose to purchase clothes on the Internet. However, when shopping online, the information of the clothes is displayed to the user in form of pictures, which makes it difficult for the user to determine whether the selected clothes are suitable for himself/herself. Since it is impossible to try on the selected clothes, the user usually goes through several times of returning due to the unfitness before purchasing the satisfactory clothes, which makes the online shopping inefficient.

At present, virtual reality may used for online shopping, and the goods of the shopping platform are presented to the user in a three-dimensional form through the virtual reality device for the user's reference. However, the user is still unable to experience the effect of trying on, so that it is impossible to determine whether the selected item is suitable.

### SUMMARY OF THE INVENTION

The embodiment of the invention provides a virtual reality based shopping method and a system, so as to solve the problem that the product is returned after receiving the goods since a user cannot try on the online shopping at present.

A virtual reality based shopping method, comprises:

acquiring a user image and user information;

establishing a shopping model corresponding to the user according to the user image and the user information;

fitting clothes onto the shopping model when the clothes selected by a user are received; and

transferring the shopping model having the clothes fitted thereon to a virtual reality device used by the user, wherein the virtual reality device presents the shopping model having the clothes fitted thereon.

In the virtual reality based shopping method, a step of acquiring the user image and the user information specifically comprises:

connecting to an external device through a network by the shopping platform; and

receiving the user image and the user information uploaded by the external device, wherein the user image is a full body photo of the user.

In the virtual reality based shopping method, a step of establishing the shopping model corresponding to the user according to the user image and the user information specifically comprises:

generating a 3D model of the user according to the user image; and

determining body shape information of the user according to the user information, and adjusting the 3D model according to the body shape information to establish the shopping model corresponding to the user.

In the virtual reality based shopping method, a step of fitting the clothes onto the shopping model when the clothes selected by the user are received specifically comprises:

determining sizes of the clothes when the clothes selected by the user are received; and

determining the sizes of the clothes to fit a display effect of the shopping model according to a preset correspondence relationship between the shopping model and the sizes of the clothes, and fitting the clothes to the shopping model with the display effect.

In the virtual reality based shopping method, a step of transferring the shopping model having the clothes fitted thereon to the virtual reality device used by the user, wherein the virtual reality device presents the shopping model having the clothes fitted thereon specifically comprises:

transferring the shopping model to the virtual reality device used by the user, wherein the virtual reality device presents the shopping model having the clothes fitted thereon, and prompting the user for a display effect of the clothes configured by the shopping model.

A virtual reality based shopping system, comprises a shopping platform and a virtual reality device;

one or more processors;

a memory; and

one or more application programs, wherein the one or more application programs are stored in the memory and executed by the processor;

wherein the shopping platform comprises an acquiring module, an establishing module, a fitting module and a transferring module;

the acquiring module is configured to acquire a user image and user information;

the establishing module is configured to establish a shopping model corresponding to the user according to the user image and the user information;

the fitting module is configured to fit clothes onto the shopping model when the clothes selected by a user are received; and

the transferring module is configured to transfer the shopping model having the clothes fitted thereon to a virtual reality device used by the user;

wherein the virtual reality device comprises a presenting module; and

the presenting module is configured to present the shopping model having the clothes fitted thereon.

In the virtual reality based shopping system, the acquiring module specifically comprises:

a connecting unit, configured to connect to an external device through a network by the shopping platform; and

a receiving unit, configured to receive the user image and the user information uploaded by the external device, wherein the user image is a full body photo of the user.

In the virtual reality based shopping system, the establishing module specifically comprises:

a model generating unit, configured to generate a 3D model of the user according to the user image; and

a model adjusting unit, configured to determine body shape information of the user according to the user information, and to adjust the 3D model according to the body shape information to establish the shopping model corresponding to the user.

In the virtual reality based shopping system, the fitting module specifically comprises:

a determining unit, configured to determine sizes of the clothes when the clothes selected by the user are received; and

a fitting unit, configured to determine the sizes of the clothes to fit a display effect of the shopping model according to a preset correspondence relationship between the shopping model and the sizes of the clothes, and to fit the clothes to the shopping model with the display effect.

In the virtual reality based shopping system, the virtual reality device further comprises a promoting module;

the promoting module is configured to promote the user for a display effect of the clothes configured by the shopping model.

A virtual reality based shopping system, comprises:

one or more processors;

a memory; and

one or more application programs, wherein the one or more application programs are stored in the memory and executed by the processor for steps;

acquiring a user image and user information;

establishing a shopping model corresponding to the user according to the user image and the user information;

fitting clothes onto the shopping model when the clothes selected by a user are received; and

transferring the shopping model having the clothes fitted thereon to a virtual reality device used by the user, wherein the virtual reality device presents the shopping model having the clothes fitted thereon.

In the virtual reality based shopping system, a step of acquiring the user image and the user information specifically comprises:

connecting to an external device through a network by the shopping platform; and

receiving the user image and the user information uploaded by the external device, wherein the user image is a full body photo of the user.

In the virtual reality based shopping system, a step of establishing the shopping model corresponding to the user according to the user image and the user information specifically comprises:

generating a 3D model of the user according to the user image; and

determining body shape information of the user according to the user information, and adjusting the 3D model according to the body shape information to establish the shopping model corresponding to the user.

In the virtual reality based shopping system, a step of fitting the clothes onto the shopping model when the clothes selected by the user are received specifically comprises:

determining sizes of the clothes when the clothes selected by the user are received; and

determining the sizes of the clothes to fit a display effect of the shopping model according to a preset correspondence relationship between the shopping model and the sizes of the clothes, and fitting the clothes to the shopping model with the display effect.

In the virtual reality based shopping system, a step of transferring the shopping model having the clothes fitted thereon to the virtual reality device used by the user, wherein the virtual reality device presents the shopping model having the clothes fitted thereon specifically comprises:

transferring the shopping model to the virtual reality device used by the user, wherein the virtual reality device presents the shopping model having the clothes fitted thereon, and prompting the user for a display effect of the clothes configured by the shopping model.

The benefits are: compared with the prior art, the present invention provides a virtual reality based shopping method. The method comprises: acquiring a user image and user information; establishing a shopping model corresponding to the user according to the user image and the user information; fitting clothes onto the shopping model when the clothes selected by a user are received; and transferring the shopping model having the clothes fitted thereon to a virtual reality device used by the user, such that the virtual reality device presents the shopping model having the clothes fitted thereon to provide shopping reference. In the present invention, by establishing the shopping model corresponding to the user, fitting clothes selected by the user onto the shopping model, and presenting the display effect through the virtual reality device to prompt the user, the user can simulate wearing the selected clothes during online shopping, and then decide whether to purchase according to the simulation try on effect, thereby improving the efficiency of online shopping.

### BRIEF DESCRIPTION OF THE DRAWINGS

FIG. 1 is a flowchart of a preferred embodiment of a virtual reality based shopping method provided by the present invention.

FIG. 2 is a flowchart of a specific embodiment of a virtual reality based shopping method provided by the present invention.

FIG. 3 is a structural diagram of a virtual reality based shopping system provided by the present invention.

FIG. 4 is a structural diagram of a virtual reality based shopping system provided by the present invention.

### DETAILED DESCRIPTION OF THE INVENTION

The present invention provides a virtual reality based shopping method and a system. For making the objectives, technical solutions and effects of the present invention more clear and definite, the present invention will be further described in detail below. It should be understood that the specific embodiments described herein are merely for explaining the present invention and are not intended to limit the present invention.

In the present invention, the use of suffixes, such as “module”, “component” or “unit” for indicating an element is merely an explanation for facilitating the present invention, and does not have a specific meaning per se. Thus, “module”, “component” or “unit” can be used, alternately for one another.

The terminal device can be implemented in various forms. For example, the terminals described in the present invention may include, a mobile terminal, such as a mobile phone, a smart phone, a notebook computer, a digital broadcast receiver, a PDA (Personal Digital Assistant), a PAD (Tablet), a PMP (Portable Multimedia Player) and a navigation device and a fixed terminal, such as digital television and a desktop computer for illustration. However, those skilled in the art will appreciate that configurations in accordance with embodiments of the present invention can be applied to fixed type terminals in addition to components that are specifically for mobile purposes.

The content of the invention will be further described by the following description of embodiments with reference to the accompanying drawings.

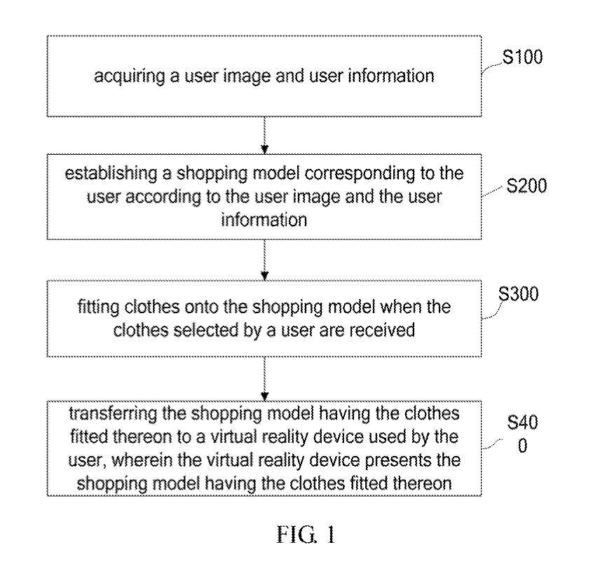

Please refer to FIG. 1. FIG. 1 is a flowchart of a preferred embodiment of a virtual reality based shopping method provided by the present invention. The method comprises:

Step S100, acquiring a user image and user information.

Specifically, the user image refers to a full body photo of the user. The user's full body photo includes a plurality of full body photos taken from various angles of view, for instance, a frontal full body photo, a left side full body photo, a right side full body photo, etc. The user information is body shape information of the user. In this embodiment, the user information includes height and weight of the user, for example, a height of 175 cm and a weight of 65 kg. Certainly, in practical application, the user information may also include body shape information of the user, such as chest circumference, waist circumference, hip circumference, etc., to provide more accurate data for establishing the shopping model of the user, so that the shopping model is closer to a real body shape of the user.

In the present embodiment, the user image is collected by an external device having a photographing function, and then the collected user image information is uploaded to the shopping platform through a network for creating a shopping model. Therefore, a step of acquiring the user image and the user information can comprise:

Step S101, connecting to an external device through a network by the shopping platform; and

Step S102, receiving the user image and the user information uploaded by the external device, wherein the user image is a full body photo of the user.

Specifically, in Step S101, the shopping platform communicates with the external device through the network to receive the user image and the user information uploaded by the external device, and issues product information for the user to browse and purchase. The external device refers to a terminal device capable of collecting the user image and communicating with the shopping platform, for instance, a PC terminal, a mobile terminal, a VR device, and the like. The user can browse the product information published by the shopping platform through the external device for shopping.

In Step S102, the external device captures the user image and saves it in a storage device of the external device. After the external device establishes a network connection with the shopping platform, the saved user image is uploaded to the shopping platform, and the shopping platform receives the user image. The user information is inputted by the user according to his/her current body data. In this embodiment, the user directly speaks the current height, weight and other information through the voice recognition function of the external device for voice input. Then, the user does not need to manually input the user information, so that the process of human-computer interaction is more user-friendly. Meanwhile, users who cannot use keyboard input can also input their current body shape information accurately and quickly. Certainly, the user information can also be manually inputted through the keyboard of the external device.

In this embodiment, in order to facilitate management of the user image and the user information, there is a process of logging in to the shopping platform by the user before the shopping platform receives the user image and the user information uploaded by the external device. The shopping platform configures an account for each user, so that each user corresponds to a unique account on the shopping platform. When the shopping platform receives the user image and the user information uploaded by the external device, the user image and the user information are automatically saved to the account corresponding to the user.

Furthermore, after the user logs in to the shopping platform through the account and uploads the user image and the user information, the shopping platform saves the user image and the user information to the account. When the user logs in to the account next time, the shopping platform may prompt the user whether to re-upload the user image and the user information. If the user selects no, the user image and user information saved last time are directly invoked, so that the user does not need to upload again to save shopping time and bring convenience to the user.

When the external device captures full photos of the user at multiple angles, by uploading to the shopping platform through the network, the shopping platform receives the user image and the user information and performs Step S200.

Step S200, establishing a shopping model corresponding to the user according to the user image and the user information.

Specifically, the shopping model refers to a three-dimensional simulation model established by simulating a body of the user, and used to try on clothes instead of the user body when the user is shopping at the shopping platform. Since the shopping model is built to simulate the body of the user, it must be modeled with the user's real body information.

Illustratively, a step of establishing the shopping model corresponding to the user according to the user image and the user information may comprise:

Step S201, generating a 3D model of the user according to the user image; and

Step S202, determining body shape information of the user according to the user information, and adjusting the 3D model according to the body shape information to establish the shopping model corresponding to the user.

Specifically, in Step S201, after the shopping platform receives the user image, the 3D model of the user is established by using photo modeling technology, and the received user image is converted into a 3D model. The photo modeling technology refers to a technique of automatically generating a three-dimensional model of a captured object by performing image processing and three-dimensional calculation on captured photos through a computer. In practical applications, Autodesk 123D can be used to create a 3D model from the user image.

Since the user image cannot reflect true height, weight, etc. of the user, after the 3D model is created, the 3D model needs to be adjusted in conjunction with the user information provided by the user to obtain the shopping model for restoring actual body shape data of the user. In Step S202, the actual body shape data of the user refers to a body type of the user. The types can be divided into different levels, for instance, A, B, C, etc. In practical applications, due to the significant difference in body shape between men and women, the body shape information can be divided into male and female according to gender. For instance, the types of male users are divided into Men-A, Men-B, Men-C, etc.; the types of female users are divided into WM-A, WM-B, WM-C, etc. Therefore, before Step S202, a gender identification process is further included, which may obtain the gender of the user according to the user's account information in the shopping platform, and may also determine the gender of the user according to the user image.

In this embodiment, a step of determining the body shape information of the user according to the user information is: the body type of the user is determined according to height and weight data of the user, for instance, male height 175 cm, weight 65 KG, corresponding level A; male height 185 cm, weight 85 KG, corresponding level B, . . . ; female height 160 cm, weight 55 KG, corresponding level WM-A; female height 165 cm, weight 60 KG, corresponding level WM-B, Thus, each group of height and weight corresponds to a body type, which facilitates the correspondence between the shopping model and the size.

In another embodiment of the present invention, since body of every person is different, the height and weight may not accurately restore the body of the user, so the height and weight in a certain range can be corresponding to a body shape level, thereby establishing a shopping model corresponding to the user information. For instance, a male height is 173-175 cm and a weight of 60-65 KG, correspond to a level of Men-A; a male height of 180-185 cm and a weight of 75-85 KG correspond to a level of Men-B, . . . .

After determining the body shape information of the user, the 3D model is adjusted according to the body shape information to generate the shopping model based on the true height and weight of the user to try on the selected clothes in the shopping platform instead of the user, thus restoring the real try-on effect.

Step S300, fitting clothes onto the shopping model when the clothes selected by a user are received.

Specifically, the clothes comprise: clothing, pants, shoes, hats, etc. A piece of the clothes carries a clothing size, such as an M-M code, a WM-M code, an M-L code, a WM-L code, etc. Since the shopping model of the user carries the body shape corresponding to the user, the different body types correspond to different clothing sizes. Therefore, before fitting the clothes, the correspondence between the shopping model and the size of the clothes is preset. The correspondence between the shopping model and the size of the clothes refers to the correspondence between the type of the body shape carried by the shopping model and the size of the clothes. For instance, the type of the body shape carried by the shopping model of the user is Men-A, and the corresponding size of the clothes is M-M code; the type of the body shape carried by the shopping model of the user is Men-B, and the corresponding size of the clothes is M-L code.

In another embodiment of the present invention, since the body shape ratios of different users are different, in order to make the shopping model more flexible as fitting clothes, a body shape level can correspond to one size range. For instance, the body shape carried by the shopping model is Men-A, and the corresponding size of the clothes may be M-M code and M-L code; the body shape carried by the shopping model is Men-A, and the corresponding size of the clothes may be M-L code and M-XL code. Then, the size of the clothes corresponding to the users with various bodies may be in a flexible range to avoid the issue that the user cannot select satisfactory clothes.

Illustratively, a step of fitting clothes onto the shopping model when the clothes selected by a user are received may specifically comprise:

Step S301, determining sizes of the clothes when the clothes selected by the user are received; and

Step S302, determining the sizes of the clothes to fit a display effect of the shopping model according to a preset correspondence relationship between the shopping model and the sizes of the clothes, and fitting the clothes to the shopping model with the display effect.

Specifically, in Step S302, the display effect refers to the fitting effect of the shopping model and the size of the clothes, which can be classified into appropriate and inappropriate. As the relationship between the acquired size and the shopping model of the user conforms to the correspondence between the preset shopping model and the size of the clothes, it is determined to be appropriate; as the relationship between the acquired size and the shopping model of the user does not conform to the correspondence between the preset shopping model and the size of the clothes, it is determined to be inappropriate. For instance, the type of the body shape carried by the current shopping model of the user is Men-A, and the corresponding size of the clothes is M-M code; if the acquired size is M-L code, then it is determined that the display effect is inappropriate.

The specific process of Step S302 may comprise:

H1, determining the corresponding size of the clothes of the current shopping model of the user according to a preset correspondence relationship between the shopping model and the sizes of the clothes.

H2, comparing the size of the clothes with the size, and if the two are different, it is determined to be inappropriate; if the two are the same, it is determined to be appropriate.

H3, fitting the clothes to the current shopping model of the user with the determined display effect.

Step S400, transferring the shopping model having the clothes fitted thereon to a virtual reality device used by the user, wherein the virtual reality device presents the shopping model having the clothes fitted thereon.

Specifically, the virtual reality device refers to a display device that can present the shopping model having the clothes fitted thereon to the user with the effect of virtual reality, for instance, VR glasses or a head mounted display. The virtual reality device receives the clothes to be fitted onto the shopping model with the display effect to present the display effect to the user to correspondingly promote the user for reference.

In this embodiment, when the fitted clothes are appropriate with the current shopping model of the user, the display interface of the virtual reality device displays an icon “V” for prompting the user that the display effect of the clothes and the current shopping model of the user is appropriate; when the fitted clothes are inappropriate with the current shopping model of the user, the display interface of the virtual reality device displays an icon “x” for prompting the user that the display effect of the clothes and the current shopping model of the user is inappropriate. Certainly, the prompting manner may also be prompting the text directly on the display interface, and if appropriate, the text “appropriate” appears; if not, the text “inappropriate” appears to prompt the user. In practical applications, the prompting manner may be the system default, or the user may set it according to his/her own preferences to meet the personalized visual needs of the user.

Certainly, the user can also determine whether it is appropriate according to the three-dimensional image of the shopping model with the fitted clothes presented by the display interface, and decide whether to purchase the clothes. By establishing the shopping model of the user and presenting the image of the shopping model fitted with the clothes to the user through the virtual reality device, when the user is shopping on the shopping platform, the user directly places the favorite clothes on the shopping model to view the try on effect, so that the user is immersive in experiencing the try on effect of physical shopping.

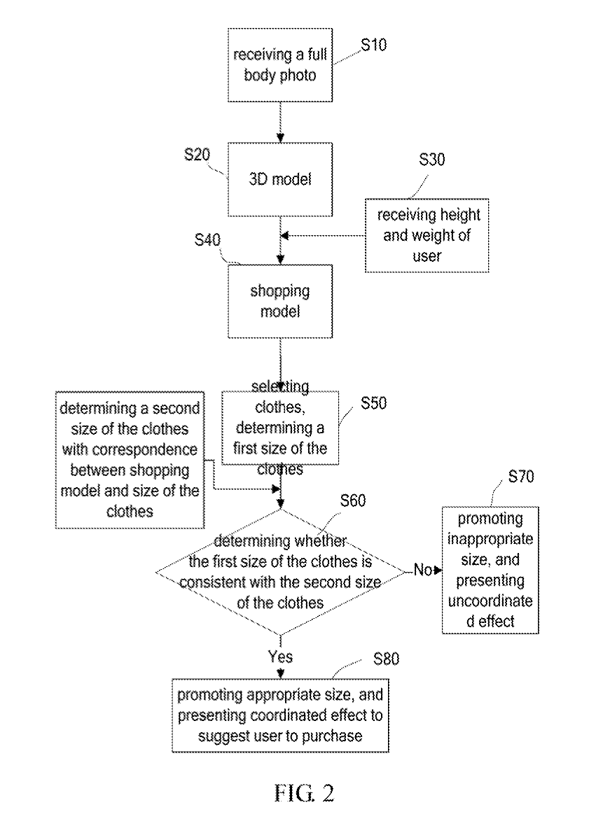

The content of the present invention is further illustrated by one specific embodiment process. As shown in FIG. 2, the virtual reality based shopping method comprises:

Step S10, receiving a full body photo uploaded by the user;

Step S20, generating a 3D model corresponding to the user according to the full body photo, wherein the 3D model retains a head image carried by the full body photo;

Step S30, receiving height and weight inputted by the user;

Step S40, adjusting the 3D model according to the received height and weight to acquire a shopping model of the user;

Step S50, receiving an operation of selecting the clothes by the user, and determining a first size of the clothes corresponding to the operation;

Step S60, determining a second size of the clothes corresponding to the shopping model according to a database of correspondence between a pre-established shopping model and the size of the clothes, and determining whether the first size of the clothes is consistent with the second size of the clothes;

Step S70, promoting inappropriate on the display interface of the virtual reality device if they are inconsistent, and presenting the uncoordinated effect to the user;

Step S80, promoting appropriate on the display interface of the virtual reality device if they are consistent, and presenting the coordinated effect to the user.

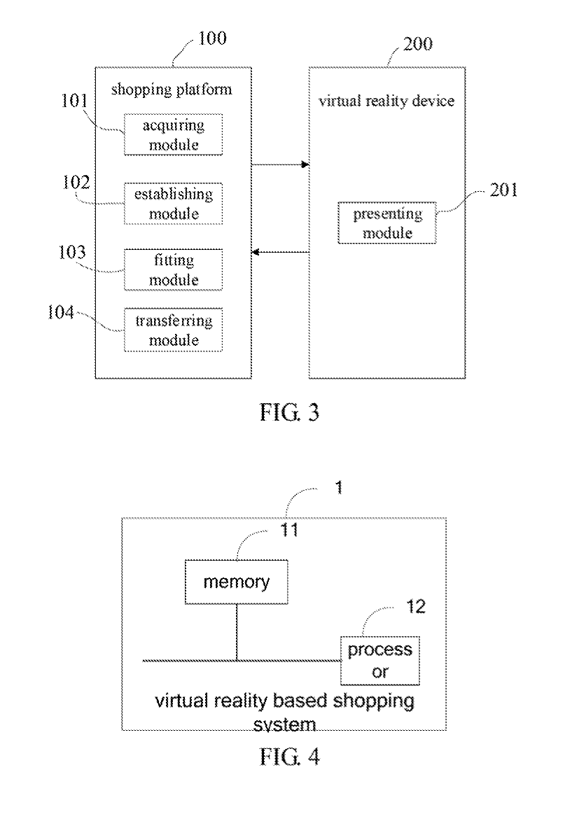

The present invention further provides a virtual reality based shopping system, comprising a shopping platform 100 and a virtual reality device 200 as shown in FIG. 3;

the shopping platform comprises an acquiring module 101, an establishing module 102, a fitting module 103 and a transferring module 104;

the acquiring module 101 is configured to acquire a user image and user information;

the establishing module 102 is configured to establish a shopping model corresponding to the user according to the user image and the user information;

the fitting module 103 is configured to fit clothes onto the shopping model when the clothes selected by a user are received; and

the transferring module 104 is configured to transfer the shopping model having the clothes fitted thereon to a virtual reality device used by the user;

wherein the virtual reality device 200 comprises a presenting module 201; and

the presenting module 201 is configured to present the shopping model having the clothes fitted thereon.

In the virtual reality based shopping system, the acquiring module specifically comprises:

a connecting unit, configured to connect to an external device through a network by the shopping platform; and

a receiving unit, configured to receive the user image and the user information uploaded by the external device, wherein the user image is a full body photo of the user.

In the virtual reality based shopping system, the establishing module specifically comprises:

a model generating unit, configured to generate a 3D model of the user according to the user image; and

a model adjusting unit, configured to determine body shape information of the user according to the user information, and to adjust the 3D model according to the body shape information to establish the shopping model corresponding to the user.

In the virtual reality based shopping system, the fitting module specifically comprises:

a determining unit, configured to determine sizes of the clothes when the clothes selected by the user are received; and

a fitting unit, configured to determine the sizes of the clothes to fit a display effect of the shopping model according to a preset correspondence relationship between the shopping model and the sizes of the clothes, and to fit the clothes to the shopping model with the display effect.

In the virtual reality based shopping system, the virtual reality device further comprises a promoting module;

the promoting module is configured to promote the user for a display effect of the clothes configured by the shopping model.

Besides, in several embodiments provided by the present invention, it should be understood that the disclosed system and method may be implemented in other ways. As an illustration, the embodiment of the device described above is merely illustrative. For example, the division of the module is only a logical function division and there are additional ways of actual implement, such as, multiple units or components may be combined or can be integrated into another system. Or, some feature can be ignored or not executed. In addition, the coupling, the direct coupling or the communication connection shown or discussed may be either an indirect coupling or a communication connection through some interfaces, devices or units, or may be electrically, mechanically or otherwise connected.

The units described as the separation means may or may not be physically separated. The components shown as units may or may not be physical units, i.e., may be located in one place or may be distributed over a plurality of network units. The part or all of the units can be selected according to the actual demands to achieve the object of the present embodiment.

The respective function units in the respective embodiments of the present invention can be integrated in one process unit, or the individual units are physically presented, or two or more units are integrated in one unit. The foregoing integrated units can be implemented in the form of hardware or in the form of a hardware and software functional unit.

The aforesaid integrated unit implemented in the form of a software functional unit can be stored in a computer readable storage medium. The software functional unit described above is stored in a storage medium and includes instructions for causing a computer device (which may be a personal computer, a server, or a network device, etc.) or a processor to perform some steps of the methods of the various embodiments of the present invention. The foregoing storage medium includes: a U disk, a mobile hard disk, a read-only memory (ROM), a random access memory (RAM), a magnetic disk, or an optical disk, which can store program codes. For instance, as shown in FIG. 4, in the embodiment of the present invention, the virtual reality based shopping system 1 comprises a processor 11 and a memory 12. The processor 11 is coupled to the memory 12. The programs are stored in the memory 12 and executed by the processor 11.

It should be noted that the above embodiments are only used to illustrate the technical solutions of the present invention, and are not limited thereto; although the present invention has been described in detail with reference to the foregoing embodiments, those skilled in the art should understand that the technical solutions described in the foregoing embodiments may be modified, or some of the technical features may be equivalently replaced; and the modifications or replacements do not deviate from the spirit and scope of the technical solutions of the embodiments of the present invention.

1. A virtual reality based shopping method, comprising:
acquiring a user image and user information, wherein a step of acquiring the user image and the user information comprises:
connecting to an external device through a network by the shopping platform; and
receiving the user image and the user information uploaded by the external device, wherein the user image is a full body photo of the user;
establishing a shopping model corresponding to the user according to the user image and the user information;
fitting clothes onto the shopping model when the clothes selected by a user are received; and
transferring the shopping model having the clothes fitted thereon to a virtual reality device used by the user, wherein the virtual reality device presents the shopping model having the clothes fitted thereon.

2. (canceled)

3. The virtual reality based shopping method according to claim 1, wherein a step of establishing the shopping model corresponding to the user according to the user image and the user information specifically comprises:
generating a 3D model of the user according to the user image; and
determining body shape information of the user according to the user information, and adjusting the 3D model according to the body shape information to establish the shopping model corresponding to the user.

4. The virtual reality based shopping method according to claim 1, wherein a step of fitting the clothes onto the shopping model when the clothes selected by the user are received specifically comprises:
determining sizes of the clothes when the clothes selected by the user are received; and
determining the sizes of the clothes to fit a display effect of the shopping model according to a preset correspondence relationship between the shopping model and the sizes of the clothes, and fitting the clothes to the shopping model with the display effect.

5. The virtual reality based shopping method according to claim 1, wherein a step of transferring the shopping model having the clothes fitted thereon to the virtual reality device used by the user, wherein the virtual reality device presents the shopping model having the clothes fitted thereon specifically comprises:
transferring the shopping model to the virtual reality device used by the user, wherein the virtual reality device presents the shopping model having the clothes fitted thereon, and prompting the user for a display effect of the clothes configured by the shopping model.

6. A virtual reality based shopping system, comprising a shopping platform and a virtual reality device;
one or more processors;
a memory; and
one or more application programs, wherein the one or more application programs are stored in the memory and executed by the processor;
wherein the shopping platform comprises an acquiring module, an establishing module, a fitting module and a transferring module;
the acquiring module is configured to acquire a user image and user information, wherein the acquiring module comprises:
a connecting unit, configured to connect to an external device through a network by the shopping platform; and
a receiving unit, configured to receive the user image and the user information uploaded by the external device, wherein the user image is a full body photo of the user;
the establishing module is configured to establish a shopping model corresponding to the user according to the user image and the user information;
the fitting module is configured to fit clothes onto the shopping model when the clothes selected by a user are received; and
the transferring module is configured to transfer the shopping model having the clothes fitted thereon to a virtual reality device used by the user;
wherein the virtual reality device comprises a presenting module; and
the presenting module is configured to present the shopping model having the clothes fitted thereon.

7. (canceled)

8. The virtual reality based shopping system according to claim 6, wherein the establishing module specifically comprises:
a model generating unit, configured to generate a 3D model of the user according to the user image; and
a model adjusting unit, configured to determine body shape information of the user according to the user information, and to adjust the 3D model according to the body shape information to establish the shopping model corresponding to the user.

9. The virtual reality based shopping system according to claim 6, wherein the fitting module specifically comprises:
a determining unit, configured to determine sizes of the clothes when the clothes selected by the user are received; and
a fitting unit, configured to determine the sizes of the clothes to fit a display effect of the shopping model according to a preset correspondence relationship between the shopping model and the sizes of the clothes, and to fit the clothes to the shopping model with the display effect.

10. The virtual reality based shopping system according to claim 6, wherein the virtual reality device further comprises a promoting module;
the promoting module is configured to promote the user for a display effect of the clothes configured by the shopping model.

11. A virtual reality based shopping system, comprising:
one or more processors;
a memory; and
one or more application programs, wherein the one or more application programs are stored in the memory and executed by the processor for steps;
acquiring a user image and user information, wherein a step of acquiring the user image and the user information specifically comprises:
connecting to an external device through a network by the shopping platform; and
receiving the user image and the user information uploaded by the external device, wherein the user image is a full body photo of the user;
establishing a shopping model corresponding to the user according to the user image and the user information;
fitting clothes onto the shopping model when the clothes selected by a user are received; and
transferring the shopping model having the clothes fitted thereon to a virtual reality device used by the user, wherein the virtual reality device presents the shopping model having the clothes fitted thereon.

12. (canceled)

13. The virtual reality based shopping system according to claim 11, wherein a step of establishing the shopping model corresponding to the user according to the user image and the user information specifically comprises:
generating a 3D model of the user according to the user image; and
determining body shape information of the user according to the user information, and adjusting the 3D model according to the body shape information to establish the shopping model corresponding to the user.

14. The virtual reality based shopping system according to claim 11, wherein a step of fitting the clothes onto the shopping model when the clothes selected by the user are received specifically comprises:
determining sizes of the clothes when the clothes selected by the user are received; and
determining the sizes of the clothes to fit a display effect of the shopping model according to a preset correspondence relationship between the shopping model and the sizes of the clothes, and fitting the clothes to the shopping model with the display effect.

15. The virtual reality based shopping method according to claim 11, wherein a step of transferring the shopping model having the clothes fitted thereon to the virtual reality device used by the user, wherein the virtual reality device presents the shopping model having the clothes fitted thereon specifically comprises:
transferring the shopping model to the virtual reality device used by the user, wherein the virtual reality device presents the shopping model having the clothes fitted thereon, and prompting the user for a display effect of the clothes configured by the shopping model.
